(19) United States
(12) Patent Application Publication
(10) Pub. No.: US 2026/0361035 A1
(43) Pub. Date: Nov. 12, 2026

(54) CABLE END CONNECTOR ASSEMBLY

(71) Applicant: BIZLINK INTERNATIONAL CORP., New Taipei City (TW)

(72) Inventors: Guang Zong HU, New Taipei City (TW); Yi-Hsing CHUNG, New Taipei City (TW); Chen-Wei YEH, New Taipei City (TW)

(21) Appl. No.: 19/668,842

(22) Filed: May 6, 2026

(30) Foreign Application Priority Data
May 6, 2025 (TW) 114204550

(51) Int. Cl. H01R 13/652; H01R 13/432; H01R 13/506; H01R 24/30; H01R 24/60

(52) U.S. Cl. CPC H01R 13/652; H01R 13/432; H01R 13/506; H01R 24/30; H01R 24/60

(57) ABSTRACT

A cable end connector assembly is provided. The cable end connector assembly includes a cable set, an insulating body, a shell body and an intermediate connecting assembly. The shell body includes an upper shell, a lower shell and a terminal group. The terminal group is electrically connected to the cable set and includes a first terminal set and a second terminal set. The intermediate connecting assembly is disposed between the first terminal set and the second terminal set, and includes: a first plate and a second plate. The first plate has at least one first hole and at least one second hole. The second plate has at least one first protrusion portion and at least one second protrusion portion. The first protrusion portion penetrates through the first hole, and the second protrusion portion penetrates through the second hole.

### CROSS- REFERENCE TO RELATED APPLICATIONS

This application claims priority to Taiwan Application Serial Number 114204550 filed May 06, 2025, which is herein incorporated by reference.

### BACKGROUND

### Technical Field

The present disclosure relates to a cable end connector assembly and, more particularly, to cable end connector assembly that ensures stable electrical conduction between adjacent terminals.

### Description of Related Art

With the increasing demands for data transmission rates and the growing needs for high-performance server systems designed for artificial intelligence (AI) computing, high-speed connectors become indispensable key components in modern electronic devices. A cable end connector assembly used for high-speed connections requires a configuration of high-density terminals within a limited space while ensuring signal integrity and stability, avoiding signal distortion or data errors due to insertion loss, return loss, and crosstalk. Although various technical solutions are proposed, existing cable end connector assembly still faces the challenge of unstable electrical conduction between terminals.

Peng et al. (China patent publication No. CN113690642B) discloses an electric connector achieving stable electrical connection between grounding terminals by using first solder pins and second solder pins of two shielding plates. The first solder pins and second solder pins are respectively distributed side by side with conductive parts of first grounding terminals and second grounding terminals in a grounding terminal group along a first direction, and the first solder pins and second solder pins are used to weld together with at least one external conductive component. Therefore, each of the shielding plates is stably electrically connected to the corresponding grounding terminals.

### SUMMARY

A cable end connector assembly is provided to solve the above problems.

In accordance with an embodiment of the present disclosure, the cable end connector assembly includes: a cable set, an insulating body, a shell body and an intermediate connecting assembly. The insulating body has a cavity. The shell body is disposed in the cavity. The shell body includes an upper shell, a lower shell and a terminal group. The terminal group includes a first terminal set and a second terminal set. The first terminal set and the second terminal set are respectively located on a top side of the upper shell and a lower side of the lower shell, and the terminal group is electrically connected to the cable set. The intermediate connecting assembly is disposed between the first terminal set and the second terminal set. The intermediate connecting assembly includes: a first plate and a second plate. The first plate has at least one first hole and at least one second hole. The second plate has at least one first protrusion portion and at least one second protrusion portion. The at least one first protrusion portion penetrates through the at least one first hole, and the at least one second protrusion portion penetrates through the at least one second hole.

### BRIEF DESCRIPTION OF THE DRAWINGS

For a more complete understanding of the present disclosure, and the advantages thereof, reference is now made to the following descriptions to be taken in conjunction with the accompanying drawings.

FIG. 1A is a schematic diagram showing a 3D structure of a cable end connector assembly in accordance with an embodiment of the present disclosure.

FIG. 1B is a schematic diagram showing a 3D structure of the cable end connector assembly removing an insulating body in accordance with an embodiment of the present disclosure.

FIG. 1C is a schematic diagram showing 3D structures of the intermediate connecting assembly and the terminal group in accordance with an embodiment of the present disclosure.

FIG. 2 is schematic diagram showing a side view of the intermediate connecting assembly and the terminal sets in accordance with an embodiment of the present disclosure.

FIG. 3 is a schematic diagram showing an explosion view of the intermediate connecting assembly in accordance with an embodiment of the present disclosure.

FIG. 4 is a schematic diagram showing a structure of the cable end connector assembly combined with a slot in accordance with an embodiment of the present disclosure.

FIG. 5 is a schematic diagram showing a structure of the cable end connector assembly combined with a slot in accordance with an embodiment of the present disclosure.

FIG. 6 is a schematic diagram showing a structure of the upper shell in accordance with an embodiment of the present disclosure.

FIG. 7 is a schematic diagram showing a structure of the lower shell in accordance with an embodiment of the present disclosure.

FIG. 8 is a schematic diagram showing the region AA in FIG. 1B in accordance with embodiment of the present disclosure.

### DETAILED DESCRIPTION

The following specification will be described in details in the following embodiments with reference to the accompanying drawings. However, the embodiments described are not intended to limit the scope of the disclosure. Moreover, it is not intended for the description of structure and operation to limit the order of implementation. Any device with equivalent functions that is produced from a structure formed by a recombination of elements shall fall within the scope of the disclosure. Furthermore, according to standards and regular practices in the industry, the drawings are shown only for purpose of facilitating illustration, and are not depicted according to the original scale.

The terms "first", "second", etc. are used herein to describe different components, these terms are used only to distinguish the elements or operations described in the same technical terms. Unless the context clearly indicates otherwise, the terms do not imply or indicate any order or sequence thereof and should not be limited by these terms.

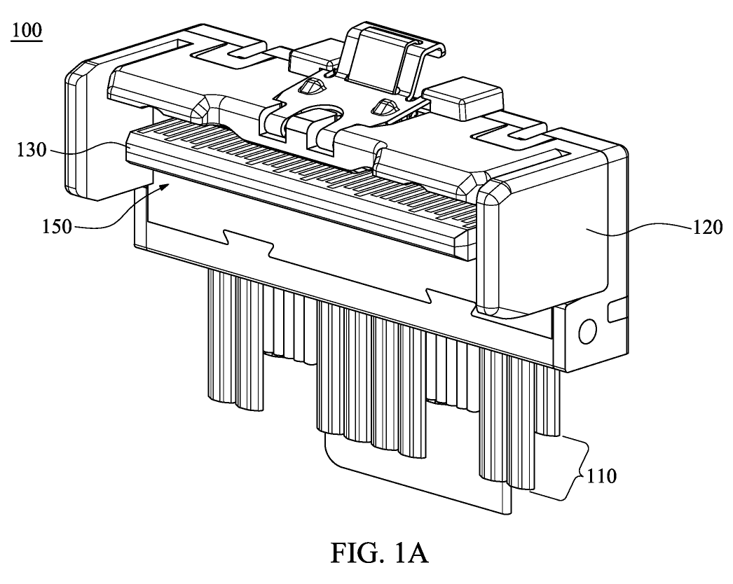

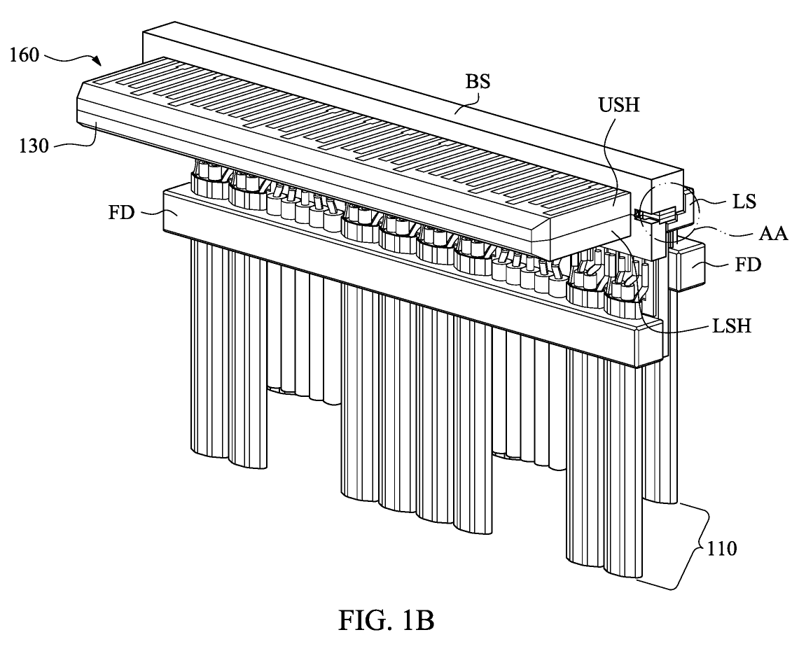

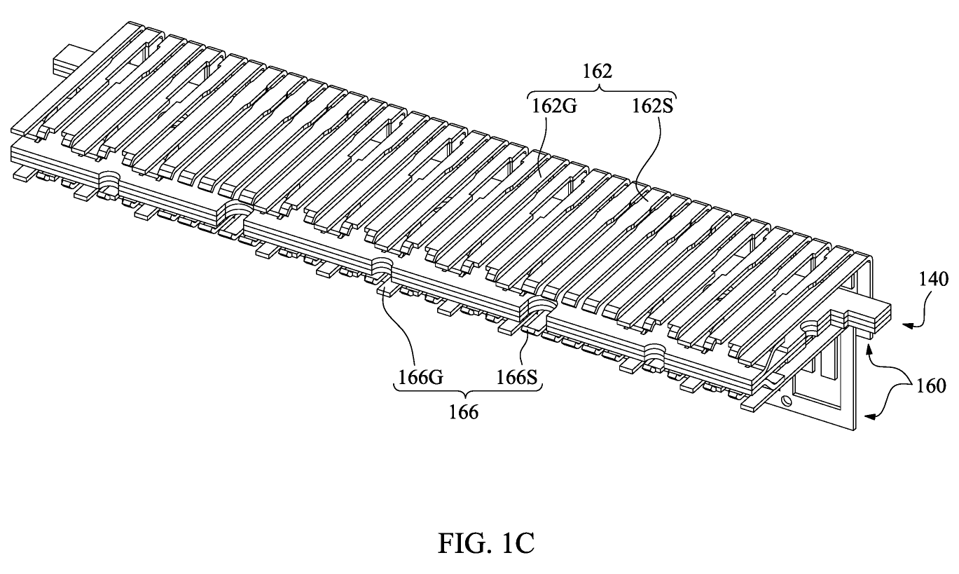

Referring to FIGS. 1A and 1B, FIG. 1A is a schematic diagram showing a 3D structure of a cable end connector assembly 100 in accordance with an embodiment of the present disclosure, and FIG. 1B is a schematic diagram showing a 3D structure of the cable end connector assembly 100 removing an insulating body 120 (as shown in FIG. 1A) in accordance with an embodiment of the present disclosure. The cable end connector assembly 100 can be a high-speed connector used in servers or similar devices that require high speed transmission for large amount of data. In some applications, the cable end connector assembly 100 can be coupled to a board end connector located within the aforementioned device for data transmission. The cable end connector assembly 100 includes an L-shaped structure LS, a cable set 110, an insulating body 120, a shell body 130 including a base seat BS, a fixing device FD and an intermediate connecting assembly (not shown). The insulating body 120 has a receiving cavity 150. The shell body 130 includes an upper shell, a lower shell and a terminal group 160. The terminal group 160 includes terminals located on the upper shell USH and lower shell LSH of the shell body 130. In some embodiments, a first terminal set of the terminal group 160 are located on a top side of the upper shell USH, and a second terminal set of the terminal group 160 are located on a lower side of the lower shell LSH. A seat portion of the upper shell USH and a seat portion of the lower shell LSH are combined to form the base seat BS of the shell body 130. In some embodiments, the terminal group 160 of the shell body 130 is bent to be electrically connected to the cable set 110. The cable set 110 includes plural cables electrically connected to the terminal group 160, and the fixing device FD disposed on the cable set 110 to fix the cable set 110.

Referring to FIG. 1C, FIG. 1C is a schematic diagram showing 3D structures of the intermediate connecting assembly 140 and the terminal group 160 in accordance with an embodiment of the present disclosure, in which the shell body 130 is omitted, The terminal group 160 includes first terminal set 162 and the second terminal set 166. The first terminal set 162 and the second terminal set 166 are located on the top side of the upper shell USH and the lower side of the lower shell LSH (as shown in FIG. 1B), respectively. The intermediate connecting assembly 140 is disposed between the first terminal set 162 and the second terminal set 166, and is electrically connected to the first terminal set 162 and the second terminal set 166. The first terminal set 162 includes first signal terminals 162S and first ground terminals 162G. The second terminal set 166 includes second signal terminals 166S and second ground terminals 166G. The first ground terminal 162G and the second ground terminal 166G are used to provide a ground reference signal, and the first signal terminal 162S and the second signal terminal 166S are used to provide data signals.

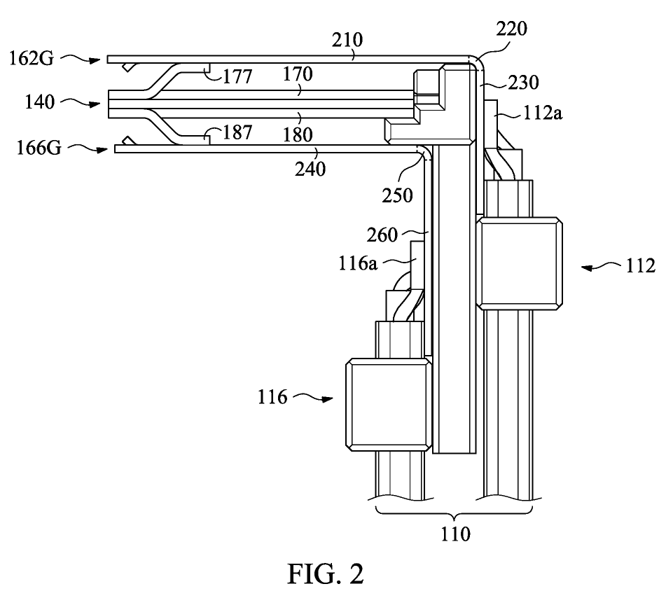

Referring to FIG. 2, FIG. 2 is schematic diagram showing a side view of the intermediate connecting assembly 140 and the terminal sets in accordance with an embodiment of the present disclosure. The cable set 110 is electrically connected to the terminal group 160 (as shown in FIG. 1B) for signal transmission through the cable set 110.

Each terminal in the first terminal set 162 has a first extension portion 210, a first bend portion 220, and a second extension portion 230. Taking the first ground terminals 162G of the first terminal set 162 as an example, the first bend portion 220 is located between the first extension portion 210 and the second extension portion 230. The first extension portion 210 contacts the intermediate connecting assembly 140 to achieve an electrical connection between the intermediate connecting assembly 140 and the first terminal set 162. The second extension portion 230 is connected to a connection portion 112a of a first cable 112 of the cable set 110 to achieve an electrical connection between the cable set 110 and the first terminal set 162.

Considering the first signal terminals 162S in the first terminal set 162, the connections between the first signal terminals 162S and the cable set 110 are similar to the connections between the first ground terminals 162G and the cable set 110. For example, the connections of the first extension portion 210, the first bend portion 220 and the second extension portion 230 of the first signal terminal 162S are similar to the connections of the first extension portion 210, the first bend portion 220 and the second extension portion 230 of the first ground terminal 162G described above, but the first extension portion 210 of the first signal terminal 162S does not contact the intermediate connecting assembly 140.

Each terminal in the second terminal set 166 has a third extension portion 240, a second bend portion 250, and a fourth extension portion 260. Taking the second ground terminals 166G of the second terminal set 166 as an example, the second bend portion 250 is located between the third extension portion 240 and the fourth extension portion 260. The third extension portion 240 contacts the intermediate connecting assembly 140 to achieve an electrical connection between the intermediate connecting assembly 140 and the second terminal set 166. The fourth extension portion 260 is connected to a connection portion 116a of a second cable 116 of the cable set 110 to achieve an electrical connection between the cable set 110 and the second terminal set 166.

Considering the second signal terminals 166S in the second terminal set 166, the connections between the second signal terminals 166S and the cable set 110 are similar to the connections between the second ground terminals 166G and the cable set 110. For example, the connections of the third extension portion 240, the second bend portion 250 and the fourth extension portion 260 of the second signal terminals 166S are similar to the connections of the third extension portion 240, the second bend portion 250 and the fourth extension portion 260 of the second ground terminal 166G described above, but the third extension portion 240 of the second signal terminals 166S does not contact the intermediate connecting assembly 140.

In this embodiment, the first bend portion 220 and the second bend portion 250 may be in an L shape, but the embodiments of the present disclosure are not limited thereto. The first plate 170 has plural first ground portions 177. The first ground portions 177 are electrically connected to the first ground terminals 162G. The second plate 180 has plural second ground portions 187. The second ground portions 187 are electrically connected to the second ground terminals 166G.

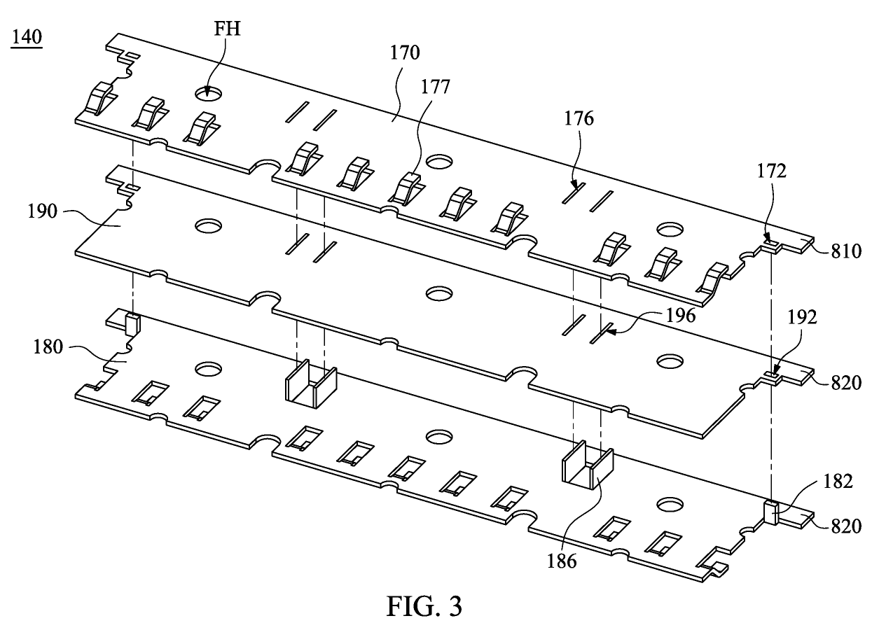

Referring to FIG. 3, FIG. 3 is a schematic diagram showing an explosion view of the intermediate connecting assembly 140 in accordance with an embodiment of the present disclosure. The intermediate connecting assembly 140 includes the first plate 170 and the second plate 180. The first plate 170 has at least one first hole 172 and at least one second hole 176. The second plate 180 has at least one first protrusion portion 182 and at least one second protrusion portion 186. The first protrusion portion 182 passes through the first hole 172, and the second protrusion portion 186 penetrates through the second hole 176. The intermediate connecting assembly 140 also includes a third plate 190 disposed between the first plate 170 and the second plate 180. The material of the first plate 170, the second plate 180, and the third plate 190 of the intermediate connecting assembly 140 are metal. The third plate 190 has at least one third hole 192 and at least one fourth hole 196. The at least one first hole 172 overlaps the at least one third hole 192, the at least one second hole 176 overlaps the at least one fourth hole 196, and the at least one first protrusion portion 182 penetrates through the at least one third hole 192, and the at least one second protrusion portion 186 penetrates through the at least one fourth hole 196. Through the above designs of the protrusions and holes, the first plate 170, the second plate 180 and the third plate 190 can be combined together. In some embodiments, the at least one first hole 172, the at least one second hole 176, the at least one third hole 192 and the at least one fourth hole 196 are in a strip shape.

In some embodiments, the at least one first hole 172 and the at least one third hole 192 are located at plate ends. For example, as shown in FIG. 3, two first holes 172 are located at opposite plate ends of the first plate 170, and four second holes 176 are located between the two first holes 172. Similarly, two first protrusion portions 182 are located at opposite plate ends of the second plate 180, and four second protrusion portions 186 are located between the first protrusion portions 182.

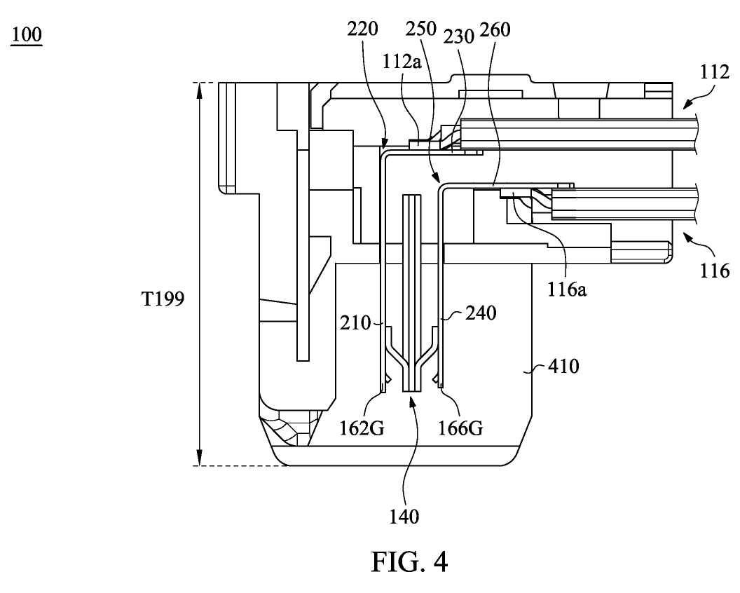

Referring to FIG. 4, FIG. 4 is a schematic diagram showing a structure of the cable end connector assembly 100 combined with a slot 410 in accordance with an embodiment of the present disclosure. The structure of the shell body 130 is not shown in FIG. 4 to facilitate the representation of the terminals of the cable end connector assembly 100 (for example, the first ground terminal 162G and the second ground terminal 166G). The intermediate connecting assembly 140 contacts the first extension portion 210 and the third extension portion 240 to ensure stable electrical conduction between adjacent terminals. Compared with conventional cable end connector assembly (not shown), since the first bend portion 220 and the second bend portion 250 of the cable end connector assembly 100 of the present disclosure are in a L shape, it helps to reduce the overall thickness T199 from 11.95 mm to 9.95 mm.

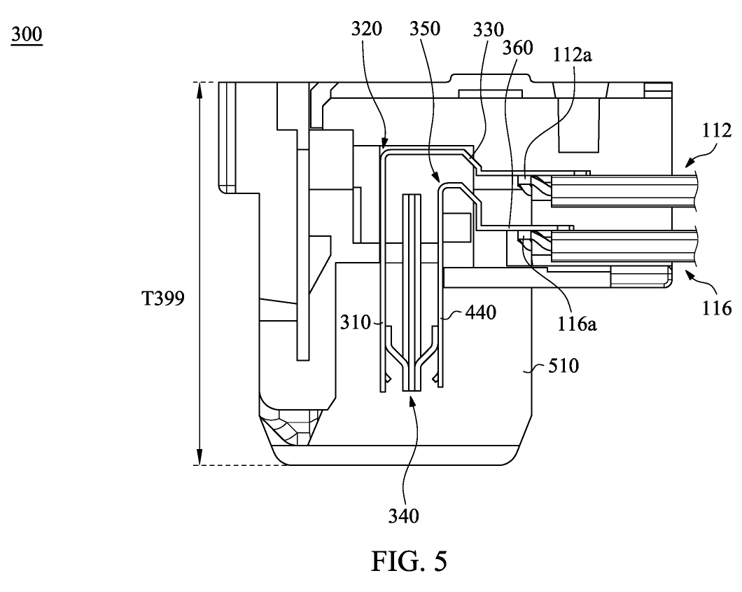

Referring to FIG. 5, FIG. 5 is a schematic diagram showing a structure of the cable end connector assembly 300 combined with a slot 510 in accordance with an embodiment of the present disclosure. The structure shown in FIG. 5 is similar to the structure shown in FIG. 4. In this embodiment, a first bend portion 320 and a second bend portion 350 of the cable end connector assembly 300 are in a L shape. An intermediate connecting assembly 340 contacts a first extension portion 310 and a third extension portion 440. The difference between the structures shown in FIGS. 5 and 4 is in that a second extension portion 330 and a fourth extension portion 360 can be designed to have various shapes according to the design of the cable end connector assembly 300 (for example, designed to have more bend portions), thereby reducing the overall structural thickness T399. Taking this embodiment as an example, compared with the conventional cable end connector assembly (not shown), it helps to reduce the thickness T399 from 11.95 mm to 9.95 mm.

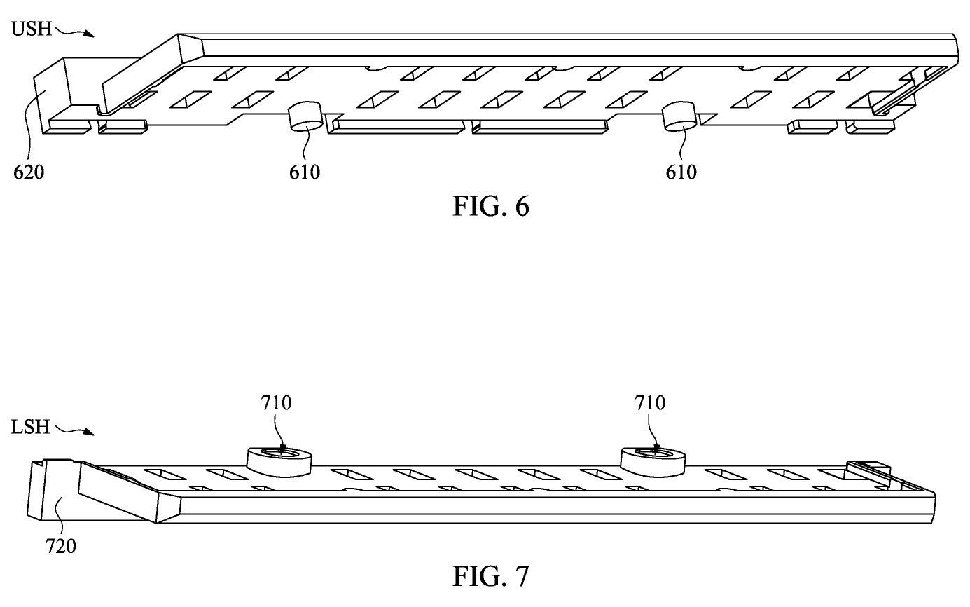

Referring to FIGS. 6 and 7, FIG. 6 is a schematic diagram showing a structure of the upper shell USH in accordance with an embodiment of the present disclosure, and FIG. 7 is a schematic diagram showing a structure of the lower shell LSH in accordance with an embodiment of the present disclosure. The upper shell USH has first fasteners 610, and the lower shell LSH has second fasteners 710 corresponding to the first fasteners 610 of the upper shell USH. The first fasteners 610 of the upper shell USH pass though fixing holes FH (as show in FIG. 3) of the first plate 170, the second plate 180 and the third plate 190 to be fastened to the second fasteners of the lower shell.

Further, the upper shell USH has a seat portion 620, and the lower shell LSH has a seat portion 720. The seat portion 620 and the seat portion 720 are laterally extended and combined to form the base seat BS as shown in FIG. 1B. In some embodiments, the base seat BS formed by the seat portion 620 and the seat portion 720 has two seat holes for receiving the laterally extending portions 810, 820 and 830.

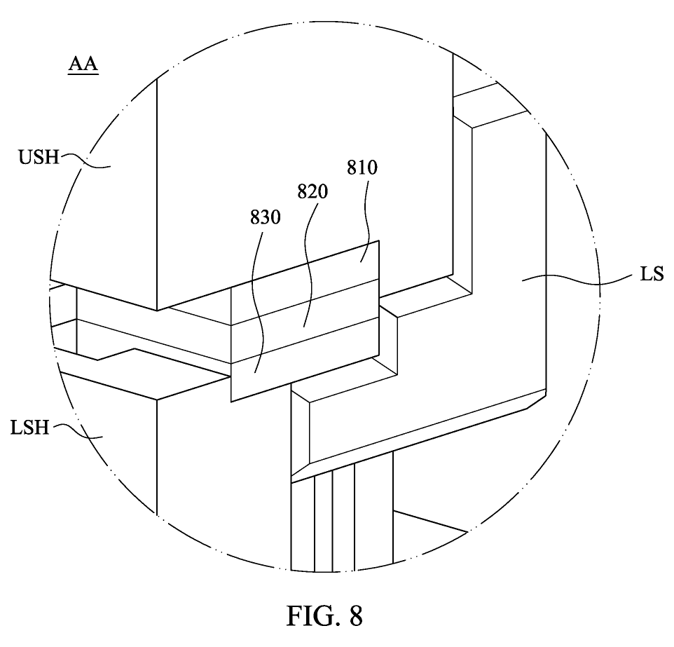

Referring to FIGS. 1B, 3 and 8 simultaneously, FIG. 8 is a schematic diagram showing the region AA in FIG. 1B in accordance with embodiment of the present disclosure. As shown in FIG. 3, the first plate 170, the second plate 180 and the third plate 190 includes plural laterally extending portions 810, 820 and 830. As shown in FIG. 8, the laterally extending portions 810, 820 and 830 are stacked and then clamped by the upper shell USH and the lower shell LSH. In other words, the seat portions of the upper shell USH and the lower shell LSH are combined to provide two opposite seat holes for receiving the laterally extending portions 810, 820 and 830 of the first plate 170, the second plate 180 and the third plate 190, thereby helping the first plate 170, the second plate 180 and the third plate 190 to be fixed to the shell body 130.

In some embodiments, the upper base portion UBS is located on a top surface of the upper shell USH at which the first terminal set 162 is located, and the lower base portion LBS is located on a bottom surface of the lower shell LSH. In other words, the upper base portion UBS and the lower base portion LBS form a receiving space to receive a portion of the shell body 130 including the upper shell USH and the lower shell LSH.

Further, the L-shaped structure LS is disposed adjacent to the base seat BS to support bend portions of the first terminal set 162 and the second terminal set 166.

In conclusion, the intermediate connecting assembly of the cable end connector assembly has a multi-layered structure having three or more layers (plates). In the multi-layered structure having the first plate, the second plate and the third plate, holes of the first plate overlap with the holes of the third plate, and the second plate has the protrusion portions that penetrates the holes of the first plate and the third plates, thereby achieving a latch structure of the intermediate connecting assembly having the multi-layered structure, and helping the multi-layered structure of the intermediate connecting assembly to be more stable and less prone to loosening. Furthermore, the first ground portion and the second ground portion of the intermediate connecting assembly respectively contact the first extension portion of the first terminal set and the third extension portion of the second terminal set, thereby ensuring stable electrical conduction between adjacent terminals. In addition, since the first bend portion and the second bend portion of the cable end connector assembly are in a L shape, the second extension portion and the fourth extension portion can be designed to have various shapes, thereby reducing the thickness of the cable end connector assembly and further reducing the whole size of the cable end connector assembly. Therefore, it is advantageous for application in electronic devices, especially high-performance servers currently designed for AI computing.

Although the present invention has been disclosed as above, it is not intended to limit the present invention. Those with ordinary knowledge in the technical field to which the present invention belongs can make various modifications and retouching without departing from the spirit and scope of the present invention. Therefore, the scope of protection of the present invention shall be deemed as defined by the scope of the attached patent application.

What is claimed is:

1. A cable end connector assembly, comprising:
a cable set;
an insulating body, wherein the insulating body has a cavity;
a shell body disposed in the cavity, wherein the shell body comprises an upper shell, a lower shell and a terminal group, the terminal group comprising a first terminal set and a second terminal set, the first terminal set and the second terminal set are respectively located on a top side of the upper shell and a lower side of the lower shell, and the terminal group being electrically connected to the cable set; and
an intermediate connecting assembly disposed between the first terminal set and the second terminal set, wherein the intermediate connecting assembly comprises:
a first plate having at least one first hole and at least one second hole; and
a second plate having at least one first protrusion portion and at least one second protrusion portion;
wherein the at least one first protrusion portion penetrates through the at least one first hole, and the at least one second protrusion portion penetrates through the at least one second hole.

2. The cable end connector assembly of claim 1, wherein the first terminal set comprises:
a plurality of first signal terminals; and
a plurality of first ground terminals disposed adjacent to the first signal terminals;
wherein the first plate has a plurality of first ground portions contacting the first ground terminals.

3. The cable end connector assembly of claim 2, wherein each of the first ground terminals has a first extension portion, a first bend portion and a second extension portion, and the first bend portion is located between the first extension portion and the second extension portion, and the first extension portion contacts the intermediate connecting assembly, and the second extension portion is connected to a first cable of the cable set.

4. The cable end connector assembly of claim 3, wherein the first bend portion is in an L shape.

5. The cable end connector assembly of claim 1, wherein the second terminal set comprises:
a plurality of second signal terminals; and
a plurality of second ground terminals disposed adjacent to the second signal terminals;
wherein the second plate has a plurality of second ground portions contact with the second ground terminals.

6. The cable end connector assembly of claim 5, wherein each of the second ground terminals has a third extension portion, a second bend portion and a fourth extension portion, and the second bend portion is located between the third extension portion and the fourth extension portion, and the third extension portion contacts the intermediate connecting assembly, and the fourth extension portion is connected to a second cable of the cable set.

7. The cable end connector assembly of claim 6, wherein the second bend portion is in an L shape.

8. The cable end connector assembly of claim 1, wherein the intermediate connecting assembly further comprises:
a third plate disposed between the first plate and the second plate.

9. The cable end connector assembly of claim 8, wherein the third plate has at least one third hole and at least one fourth hole, the at least one first hole overlaps the at least one third hole, the at least one second hole overlaps the at least one fourth hole, the at least one first protrusion portion penetrates through the at least one third hole, and the at least one second protrusion portion penetrates through the at least one fourth hole.

10. The cable end connector assembly of claim 9, wherein the at least one first hole, the at least one second hole, the at least one third hole and the at least one fourth hole are in a strip shape.

11. The cable end connector assembly of claim 8, wherein the first plate, the second plate, and the third plate of the intermediate connecting assembly are made of metal.

12. The cable end connector assembly of claim 1, wherein the first plate has two first holes, one of the first holes is located at a first plate end of the first plate, another one of the first holes is located at a second plate end of the first plate, the first plate end is opposite to the second plate end, the first plate has plural second holes, and the second holes are located between the two first holes.

13. The cable end connector assembly of claim 1, wherein the upper shell has a plurality of first fasteners, the lower shell has a plurality of second fasteners, and the first fasteners pass through fixing holes of the first plate and the second plate to be fastened to the second fasteners of the lower shell.

14. The cable end connector assembly of claim 1, wherein the second plate has two first protrusion portions, one of the first protrusion portion is located at a third plate end of the second plate, another one of the first protrusion portions is located at a fourth plate end of the second plate, and the third plate end is opposite to the fourth plate end.

15. The cable end connector assembly of claim 1, wherein the first plate and the second plate comprise laterally extending portions clamped by the upper shell and the lower shell.

16. The cable end connector assembly of claim 1, wherein a seat portion of the upper shell and a seat portion of the lower shell are combined to form a base seat of the shell body.

17. The cable end connector assembly of claim 16, wherein the base seat has first base hole and a second base hole provided by the combined seat portions of the upper shell and the lower shell.

18. The cable end connector assembly of claim 17, wherein the holes of the base seat receive laterally extending portions of the first plate and the second plate.

19. The cable end connector assembly of claim 16, further comprising:
an L-shaped structure disposed adjacent to the base seat to support bend portions of the first terminal set and the second terminal set.

20. The cable end connector assembly of claim 1, further comprising a fixing device disposed on the cable set to fix the cable set.
